(19) United States
(12) Patent Application Publication
(10) Pub. No.: US 2026/0088663 A1
(43) Pub. Date: Mar. 26, 2026

(54) STATOR FOR A ROTATING FIELD MACHINE

(71) Applicant: ENGIRO GmbH, Aachen (DE)

(72) Inventor: Bernhard Burkhart, Eupen (BE)

(21) Appl. No.: 19/109,834

(22) PCT Filed: Sep. 15, 2023
(86) PCT No.: PCT/EP2023/075454

§ 371 Date: Mar. 7, 2025

(30) Foreign Application Priority Data
Sep. 16, 2022 (DE) 10 2022 123 854.7

(51) Int. Cl. H02K 1/14; H02K 3/28; H02K 15/022; H02K 15/026; H02K 15/33

(52) U.S. Cl. CPC H02K 1/146; H02K 3/28; H02K 15/022; H02K 15/026; H02K 15/33

(57) ABSTRACT

A stator for a rotary induction motor with a stator main body, the stator being assigned a geometric machine axis, the stator having stator slots and a stator coil arrangement with a plurality of stator coil strands, which can be connected to a rotary supply voltage at respective phase terminals in order to generate a rotary magnetic field, the stator coil strings each having a bundle with a plurality of conductors, the conductors of a bundle being arranged together to form respective star inductors in the stator slots, and the conductors each having a phase-connection-side portion and a star-point-side portion, the conductors of a bundle being electrically connected to the phase connection of the respective stator coil string via the phase-connection-side portion. The conductors of bundles of different stator coil strings are electrically connected to one another via the star-point-side portion by means of respective star points.

### CROSS-REFERENCE TO RELATED APPLICATIONS

This application is a national stage application under 35 U.S.C. 371 of International Patent Application Serial No. PCT/EP2023/075454, entitled “Stator for a Rotating Field Machine,” filed Sep. 15, 2023, which claims priority from German Patent Application No. DE 10 2022 123 854.7, filed Sep. 16, 2022, the disclosure of which is incorporated herein by reference.

### FIELD OF THE TECHNOLOGY

Various embodiments relate to a stator for a rotary induction motor, a rotary induction motor and a method for producing a stator for a rotary induction motor.

### SUMMARY

The induction motor in question can be used for a wide range of applications. Examples of applications include electric motors and generators for land, air and water vehicles. Other applications can be found in the field of industrial automation and power generation.

The stator has a stator coil arrangement with several stator coil strings, which can be connected to a rotary supply voltage at respective phase connections to generate a rotary magnetic field. The stator coil strings are electrically connected to a star point in a star connection.

The stator coil strings are at least partially formed by respective bundles of conductors, particularly for higher outputs to be implemented by the induction motor. This allows the required cross-section of the stator coil strings to be provided by several conductors. The conductors of the bundles of stator coil strings are usually brought together at a common star point and electrically connected to each other there. The star inductors are each formed by a plurality of conductors connected in parallel.

The use of bundles of conductors can simplify the overall processing of the stator coil strings, in particular the production of windings for the star inductors, and reduce AC losses. However, it is a challenge that the design of the conductors of the bundles can lead to additional electrical losses.

Various embodiments address the problem of designing and developing a stator for a rotary induction motor in such a way that the electrical losses in the stator coil arrangement are further reduced.

The above problem is solved by various features described herein.

Embodiments assume that the stator coil strings each have a bundle with several conductors, with the conductors of a bundle being arranged together in the stator slots to form respective star inductors of the stator coil string. The conductors each have a phase-connection-side portion and a star-point-side portion, with the conductors of a bundle being electrically connected to the phase connection of the respective stator coil string via the phase-connection-side portion.

Various embodiments are based on the fundamental realization that voltage differences can occur between the individual conductors due to variations in the position and length of the conductors in particular. The conventionally provided short-circuit of the star-point-side portions of the conductors of different stator coil strings at a single, common star point can lead to circular currents and thus to considerable electrical losses due to the resultant direct parallel connection of the conductors of the respective bundles.

The fundamental consideration that the conductors of the bundles of a stator coil string are interconnected via several independently provided star points is now key. The resulting separation into star connections for the individual conductors largely suppresses circulating currents in the conductors of a bundle.

In detail, it is proposed that the conductors of bundles of different stator coil strings are electrically connected to each other via the star-point-side portion by means of respective star points and that the star points are electrically decoupled from each other.

In various embodiments, respective star point triplets electrically insulated from one another are provided, so that a star-delta circuit for the stator coil strings can also be implemented on the basis of the teachings of the present disclosure. In various embodiments, delta inductors provided between the star points of the star point triplets are formed by further bundles of conductors.

In various embodiments, the conductors of a bundle are geometrically arranged in a sequence in the stator slots and are therefore at least partially ordered. However, the conductors of different stator coil strings are electrically connected to each other via the star points in a disordered manner, so that any voltage differences occurring due to the arrangement and lengths of the conductors are at least partially statistically compensated. Accordingly, the occurrence of voltage differences can be largely minimized.

The bundles of conductors can be used with wound inductors, which is the subject of some embodiments. A configuration as plugged inductors using hairpins is also conceivable. Further embodiments of the bundles are provided herein.

According to various embodiments, a rotary induction motor with a stator according to the proposal and a rotor which interacts magnetically with the stator coil arrangement is provided. Reference may be made to all explanations concerning the proposed stator.

According to various embodiments,, a method for producing a stator for a rotary induction motor is provided. It is key here that the conductors of bundles of different stator coil strings are electrically connected to one another via the star-point-side portion by means of respective star points and that the star points are electrically decoupled from one another. Reference may also be made to all explanations of the proposed stator.

Various embodiments provide a stator for a rotary induction motor with a stator main body, the stator being assigned a geometric machine axis, the stator having stator slots and a stator coil arrangement with a plurality of stator coil strands, which can be connected to a rotary supply voltage at respective phase terminals in order to generate a rotary magnetic field, the stator coil strings each having a bundle with a plurality of conductors, the conductors of a bundle being arranged together to form respective star inductors of the stator coil string in the stator slots, and the conductors each having a phase-connection-side portion and a star-point-side portion, the conductors of a bundle being electrically connected to the phase connection of the respective stator coil string via the phase-connection-side portion, wherein the conductors of bundles of different stator coil strings are electrically connected to one another via the star-point-side portion by means of respective star points, and wherein the star points are electrically decoupled from one another.

In various embodiments, the conductors of bundles of different stator coil strings are connected to one another via the star-point-side portion by means of star point triplets. In various embodiments, that the star point triplets are designed to be electrically decoupled from one another.

In various embodiments, the stator coil arrangement has further bundles with a plurality of conductors, wherein the conductors of the further bundles are each arranged together to form delta inductors in the stator slots, and wherein the conductors of the further bundles connect the star points of the star point triplets to one another in a respective delta circuit.

In various embodiments, each conductor of a bundle is assigned exactly one star point or exactly one star point triplet, to which the star-point-side portion is electrically connected.

In various embodiments, the conductors of a bundle are arranged geometrically in a sequence with a respective conductor index in order to form the respective star windings in the stator slots, and wherein the conductors of bundles of different stator coil strings with different conductor indices are electrically connected to one another via the star-point-side portion.

In various embodiments, the star inductors are designed as star windings. In some embodiments, the delta inductors are designed as delta windings.

In various embodiments, the star inductors are each formed by a plurality of inductors, in particular star windings, electrically connected in series to a conductor.

In various embodiments, the number of conductors per bundle is at most 20, at most 10, or at most 7.

In various embodiments, for connecting the conductors of bundles of different stator coil strings via the star-point-side portion, electrical connecting elements are provided, in particular arranged axially with respect to the machine axis on a stator front side and/or a stator rear side. In various embodiments, the connecting elements are provided as connecting conductors, connecting rails and/or connecting terminals.

Various embodiments provide a rotary induction motor with a stator as described herein and a rotor which interacts magnetically with the stator coil arrangement.

Various embodiments provide a method for producing a stator for a rotary induction motor, with a stator main body being provided, with a geometric machine axis being assigned to the stator, with a stator coil arrangement with a plurality of stator coil strings being provided, which can be connected to a rotary supply voltage at respective phase connections in order to generate a rotary magnetic field, the stator coil strings each having a bundle with a plurality of conductors, the conductors of a bundle being arranged together to form respective star inductors in stator slots in the stator main body, and the conductors each having a phase-connection-side portion and a star-point-side portion, the conductors of a bundle being electrically connected to the phase connection of the respective stator coil string via the phase-connection-side portion, wherein the conductors of bundles of different stator coil strings are electrically connected to one another via the star-point-side portion by means of respective star points, and wherein the star points are electrically decoupled from one another.

In various embodiments, the star inductors are produced as star windings by means of a flyer winder. In various embodiments, the stator coil arrangement has further bundles with a plurality of conductors, wherein the conductors of the further bundles are each arranged together to form delta windings in the stator slots, and wherein the conductors of the further bundles connect the star points of star point triplets to one another in a respective delta circuit, and wherein the delta inductors are produced as delta windings by means of a flyer winder.

### BRIEF DESCRIPTION OF THE DRAWINGS

In the following, various aspects are explained in more detail with the aid of a drawing showing only exemplary embodiments. In the drawing

FIG. 1 is a schematic representation of a proposed stator,

FIG. 2 shows a circuit diagram of the stator coil arrangement in a first embodiment,

FIG. 3 shows a circuit diagram of the stator coil arrangement in a second embodiment and

FIG. 4 shows a circuit diagram of the stator coil arrangement in a third embodiment.

### DETAILED DESCRIPTION

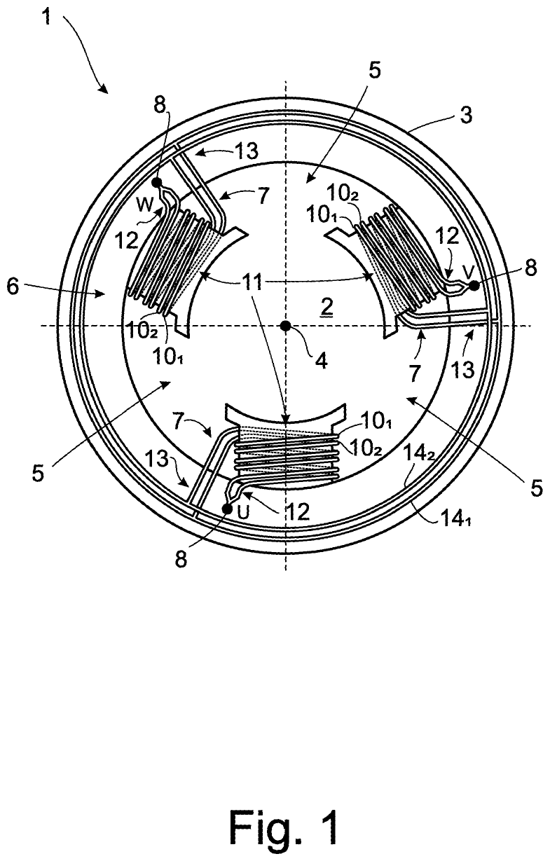

The stator 1 shown in FIG. 1 can be used for a wide range of rotary induction motors, in particular electric motors and generators. This includes, for example, synchronous machines, which can be self-excited or externally excited, asynchronous machines or the like.

The stator 1 can include a hollow stator interior 2 to accommodate a rotor, not shown. Alternatively, however, the rotor can also be arranged outside the stator 1, particularly if the induction motor is an external rotor. In this case, the stator interior 2 can even be dispensed with. In various embodiments, the induction motor is designed as an axial flux motor. Furthermore, the stator 1 has a metal stator main body 3, a geometric machine axis 4 being assigned to the stator 1. The stator main body 3 has stator slots 5. In the variant shown here with a hollow stator interior 2, stator slots 5 are distributed around the machine axis 4 and arranged in the stator main body 3. FIG. 1 shows a simplified design of the stator 1 in a schematic representation with a machine axis 4 running perpendicular to the plane of the drawing.

A stator coil arrangement 6 is used to generate a rotary magnetic field that interacts with the above rotor. For this purpose, the stator coil arrangement 6 forms electromagnetic poles in the energized state, the formation of which depends on the structure of the stator coil arrangement 6. The proposed solution can be implemented with different structures for the stator coil arrangement 6.

In various embodiments, the stator coil arrangement 6 forms several, such as three, stator coil strings 7, each of which has at least one stator coil. FIG. 1 shows one stator coil per stator coil string. In principle, several stator coils can be provided per stator coil string 7, in particular to form pairs of stator coils, which are distributed around the machine axis 4. The term “stator coil string” is therefore to be interpreted broadly in the present case. It includes any interconnection of a number of stator coils. The stator coil strings 7 can be connected to a rotary supply voltage u, v, w at respective phase connections 8 to generate the rotary magnetic field. The rotary supply voltage u, v, w can be a supply voltage with any number of phases, but in various embodiments with three phases.

The stator coil strings 7 each have a bundle 9 with several conductors 10₁, 10₂, . . . 10ₙ, the conductors 10₁, 10₂, . . . 10ₙ of a bundle 9 being arranged together to form respective star inductors 11 in the stator slots 5. The term “bundle” here means that individual conductors 10₁, 10₂, . . . 10ₙ are electronically combined and interconnected in a manner to be explained in more detail. The conductors 10₁, 10₂, . . . 10ₙ of a bundle 9 therefore do not necessarily have to be in a specific geometric arrangement. However, the bundles 9 are provided together in the stator slots 5, which means that the conductors 10₁, 10₂, . . . 10ₙ of a bundle 9 run at least partially in the same stator slots 5 and at least partially in the same direction. In various embodiments, however, the conductors 10₁, 10₂, . . . 10ₙ of a bundle 9 also run geometrically next to each other at least in portions, as can be seen from FIG. 1. The conductors 10₁, 10₂, . . . 10ₙ of a bundle 9 can also be twisted together, for example, and guided together through stator slots 5. In various embodiments, the conductors 10₁, 10₂, . . . 10ₙ of a bundle 9 are of the same type and, for example, have an identical cross-section and/or are made of the same material, such as a copper wire.

The conductors 10₁, 10₂, . . . 10ₙ each have a phase-connection-side portion 12 and a star-point-side portion 13. In various embodiments, the phase-connection-side portion 12 and the star-point-side portion 13 are respective opposite end portions of the conductors 10₁, 10₂, . . . 10ₙ.

The conductors 10₁, 10₂, . . . 10ₙ of a bundle 9 are electrically connected to the phase connection 8 of the respective stator coil string 7 via the phase-connection-side portion 12. This divides the stator coil string 7—starting from the phase connection 8—with the bundle 9 into several adjacent conductors 10₁, 10₂, . . . 10ₙ, so to speak. In various embodiments, there is an electrical contact point of all conductors 10₁, 10₂, . . . 10ₙ of a bundle 9 of the stator coil string 7 at the phase connection 8 or at a supply line provided to the phase connection 8.

It is now essential that the conductors 10₁, 10₂, . . . 10ₙ of bundles 9 of different stator coil strings 7 are electrically connected to each other via the star-point-side portion 13 by means of respective star points 14₁, 14₂, . . . 14ₙ and that the star points 14₁, 14₂, . . . 14ₙ are electrically decoupled from each other.

Instead of the conventional electrical connection of the conductors 10₁, 10₂, . . . 10ₙ of the bundles 9 to a common star point 14₁, 14₂, . . . 14ₙ, several star points 14₁, 14₂, . . . 14ₙ are provided according to the proposal, which electrically connect conductors 10₁, 10₂, . . . 10ₙ of bundles 9 of different stator coil strings 7 to each other. An “electrically decoupled” design of the star points 14₁, 14₂, . . . 14ₙ means that electrical contact between the star-point-side portions 13 of the conductors 10₁, 10₂, . . . 10ₙ Via the star points 14 does not exist or is sufficiently low, so that electrical currents between the star points 14₁, 14₂, . . . 14ₙ are suppressed under the conditions occurring during operation of the rotary induction motor. In this respect, the star points 14₁, 14₂, . . . 14ₙ can also be connected to each other via comparatively high resistances or indirectly, for example via a star conductor connection. However, it can be in various embodiments that the star points 14₁, 14₂, . . . 14ₙ remain at a floating potential in relation to each other. In particular, the star points 14₁, 14₂, . . . 14ₙ are electrically connected only indirectly via the stator coil strings 7, in this case via the phase connections 8.

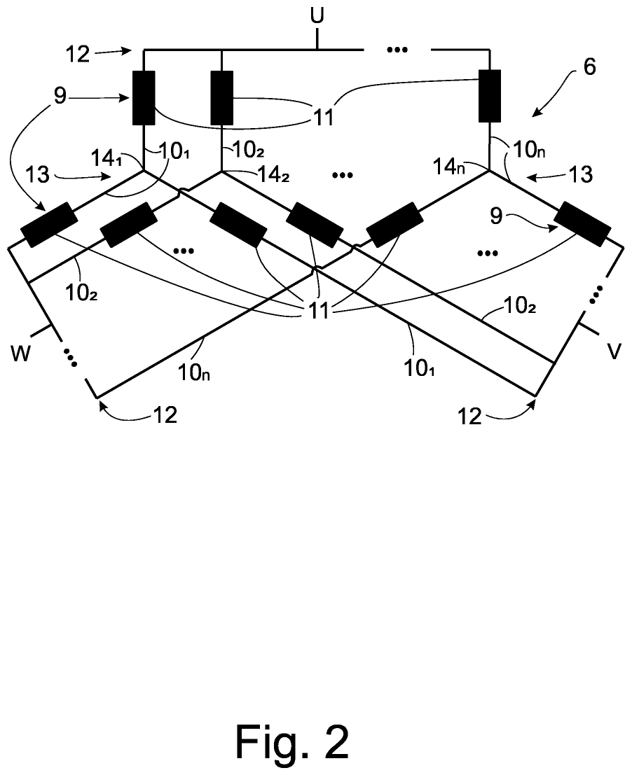

FIG. 2 shows a circuit diagram for a first embodiment of the stator 1, the conductors 10₁, 10₂, . . . 10ₙ of the bundles 9 being assigned respective individual star points 14₁, 14₂, . . . 14ₙ that are electrically decoupled from each other. This basically implements several star connections connected in parallel with the phase connections 8, each of the parallel star connections, in some embodiments being formed via one or more conductors 10₁, 10₂, . . . 10ₙ of the bundles 9 of the respective stator coil strings 7 and the respective star point 14₁, 14₂, . . . 14ₙ.

Any voltage differences due to the arrangement and individual properties of the conductors 10₁, 10₂, . . . 10ₙ are largely irrelevant here. Compared to a conventional star circuit with bundles 9, significantly higher electrical resistance occurs for circular currents in the conductors 10₁, 10₂, . . . 10ₙ, since, for example, a circular current between two stator coil strings 7 passes through the star inductors 11 of both stator coil strings 7.

To connect the conductors 10₁, 10₂, . . . 10ₙ of different stator coil strings 7, groups of several star points 14₁, 14₂, . . . 14ₙ, in particular those that are electrically decoupled from each other, can also be provided. In the further embodiment shown in FIG. 2, it is provided that the conductors 10₁, 10₂, . . . 10ₙ of bundles 9 of different stator coil strings 7 are connected to each other via the star-point-side portion 13 by means of star point triplets 15₁, 15₂, . . . 15ₙ, in some embodiments that the star point triplets 15₁, 15₂, . . . 15ₙ are electrically decoupled from each other.

The star point triplets 15₁, 15₂, . . . 15ₙ are electrically connected to each other, such as via a delta circuit, so that a star-delta circuit is achieved overall between the phase connections 8 for the stator coil arrangement 6.

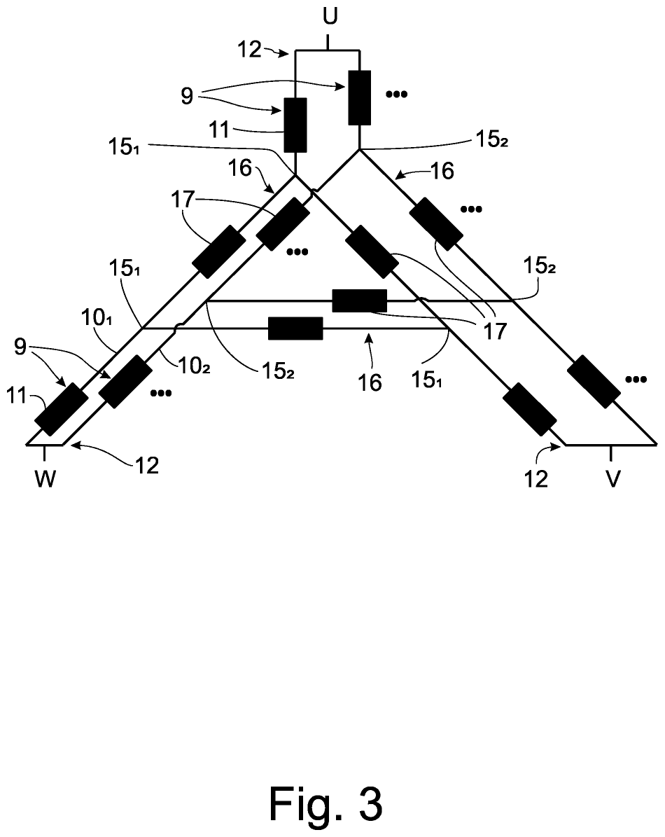

Furthermore, according to FIG. 3, it is provided that the stator coil arrangement 6 has further bundles 16 with several conductors 10₁, 10₂, . . . 10ₙ, that the conductors 10₁, 10₂, . . . 10ₙ of the further bundles 16 are each arranged together to form delta inductors 17 in the stator slots 5, and that the conductors 10 of the further bundles 16 connect the star points of the star point triplets 15₁, 15₂, . . . 15ₙ to one another in a respective delta circuit.

FIG. 3 shows the circuit diagram of the stator coil string 6 of a further embodiment of the stator 1. Here, basically several star-delta circuits connected in parallel with the phase connections 8 are implemented, each of the parallel star-delta circuits such as being formed via one or more conductors 10₁, 10₂, . . . 10ₙ of the bundles 9 of the respective stator coil strings 7, three or more conductors 10₁, 10₂, . . . 10ₙ of the further bundles 16 and the respective star point triplet 15₁, 15₂, . . . 15ₙ. Here, and in various embodiments, three further bundles 16 are provided, wherein in various further embodiments the number of conductors 10₁, 10₂, . . . 10ₙ of the further bundles 16 corresponds to the number of conductors 10₁, 10₂, . . . 10ₙ of the bundles 9 of the stator coil strings 7.

In principle, it is conceivable that several star points 14₁, 14₂, . . . 14ₙ are provided, but several conductors 10₁, 10₂, . . . 10ₙ of a bundle 9 are electrically connected to one or more of these star points 14₁, 14₂, . . . 14ₙ. However, it can be that each conductor 10₁, 10₂, . . . 10ₙ of a bundle 9 is assigned exactly one star point 14₁, 14₂, . . . 14ₙ or exactly one star point triplet 15₁, 15₂, . . . 15ₙ, to which the star-point-side portion 13 is electrically connected. This optimally suppresses the occurrence of ring currents in the stator coil arrangement 6.

In one embodiment, it is provided that the conductors 10₁, 10₂, . . . 10ₙ of a bundle 9 are arranged geometrically in a sequence with a respective conductor index to form the respective star windings in the stator slots 5.

Such a sequence can result from the fact that the conductors 10₁, 10₂ are arranged, in particular wound, next to each other in the stator slots 5 as shown in FIG. 1. Accordingly, there is a certain regularity in the geometric arrangement of the conductors 10₁, 10₂, . . . 10ₙ in relation to each other. For example, the conductors 10₁, 10₂ in FIG. 1, viewed from the machine axis 4 in the radial direction, are present in the stator coils in the sequence (10₁-10₂-10₁-10₂-10₁-10₂). This can result in systematic deviations in the properties of the conductors 10₁, 10₂, which in turn could lead to voltage differences.

Therefore, the conductors 10₁, 10₂, . . . 10ₙ of bundles 9 of different stator coil strings 7 with different conductor indices can be electrically connected to each other via the star-point-side portion 13. In FIG. 1, for example, the conductor 10₁ intended for the three-phase supply voltage U and the conductors 10₂ intended for the three-phase supply voltage V, W are connected to the star point 14₂. Systematic deviations in the properties of the conductors 10₁, 10₂, . . . 10ₙ can be at least partially compensated for by “mixing” the conductor indices, which in turn results in lower voltage differences overall.

It is possible in some embodiments to apply the proposed teaching to stators 1 with wound stator coil arrangements 6. In various embodiments, it is provided that the star inductors 11 are designed as star windings. In the aforementioned embodiments with delta inductors 17, it is provided that the delta inductors 17 are designed as delta windings.

Alternatively or additionally, it is also conceivable that the stator coil arrangement 6 is at least partially plugged, with the star inductors 11 and/or delta inductors 17 being formed by bundles 9 with several hairpins as conductors 10₁, 10₂, . . . 10ₙ. In this case, fewer requirements are placed on the geometry of the hairpins.

In FIG. 1, the stator 1 is shown schematically in a simple configuration with concentrated inductors and only three star inductors 11 designed as star windings. All of the present explanations apply accordingly to other possible structural configurations of the stator coil arrangement 6. In various embodiments of the stator 1, the stator coil arrangement 6 is designed with distributed inductors, in particular distributed star windings. As already mentioned, a higher number of stator coils and in particular stator coil pairs is possible.

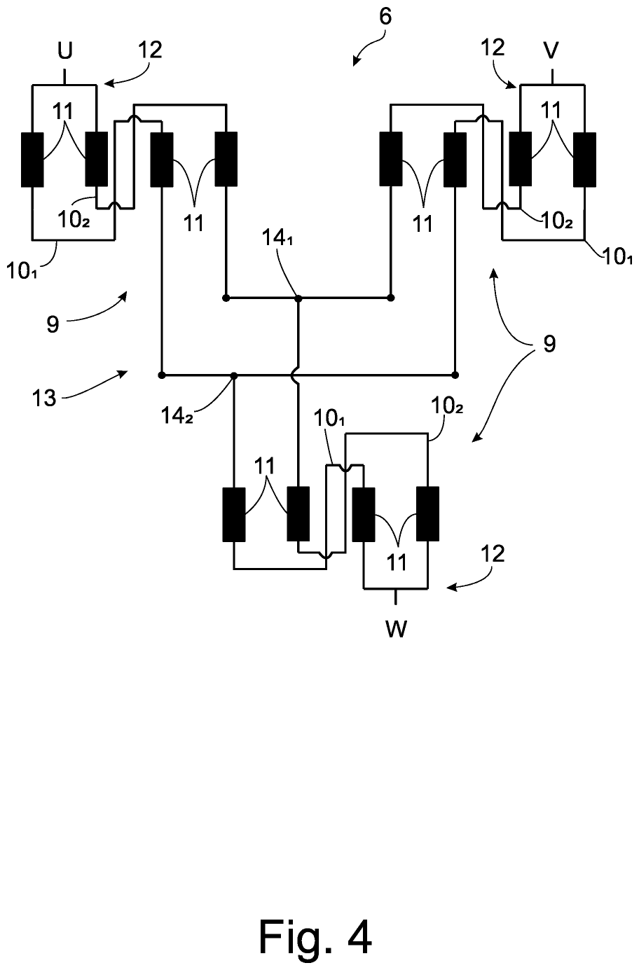

The star inductors 11 can each be formed by a plurality of inductors, in particular star windings, electrically connected in series to a conductor 10₁, 10₂, . . . 10ₙ. FIG. 4 shows a further circuit diagram which, in addition to the circuit diagram in FIG. 1, has a respective series connection of inductors, in this case windings, for each of the conductors 10₁, 10₂, . . . 10ₙ, which form the star inductors 11. For example, the series-connected inductors of a conductor 10₁, 10₂, . . . 10ₙ are arranged in different stator slots 5. In the present case, the 10₁, 10₂, . . . 10ₙ are also electrically decoupled from each other between the series-connected inductors in order to prevent possible circulating currents.

At least two conductors 10₁, 10₂, . . . 10ₙ are provided per bundle 9. It can further be that the number of conductors 10₁, 10₂, . . . 10ₙ per bundle 9 can be at most 20 or at most ten.

In particular, a maximum number of seven conductors 10₁, 10₂, . . . 10ₙ per bundle 9 results in improved processing of the conductors 10 with an optimum overall cross-section of the bundles 9 for many applications.

To connect the conductors 10₁, 10₂, . . . 10ₙ of bundles 9 of different stator coil strings 7, electrical connecting elements are provided, in various embodiments via the star-point-side portion 13, in particular arranged axially in relation to the machine axis 4 at a stator front side and/or a stator rear side.

In various embodiments, the connecting elements are provided as connecting conductors, connecting rails and/or connecting terminals, so that overall a simplified provision of the multiple star points 14₁, 14₂, . . . 14ₙ is achieved. For example, a conductor such as a wire can also be used as the connecting conductor. In a simple case, the conductors 10₁, 10₂, . . . 10ₙ of the bundles 9 are connected to each other in an integrally bonded manner to form the respective star point 14₁, 14₂, . . . 14ₙ.

FIG. 1 shows an embodiment of the connecting elements with a connecting rail, which is arranged on the front or rear side of the stator and runs, for example, in a ring along the stator main body 3. The respective conductors 10₁, 10₂, . . . 10ₙ can be electrically connected to the connecting rail. In particular, a connecting terminal provides an electrical connection of the conductors 10₁, 10₂, . . . 10ₙ to a respective star point 14₁, 14₂, . . . 14ₙ, which is not based on an integrally bonded connection.

According to a further teaching, which is of independent significance, a rotary induction motor, not shown, is proposed with a stator 1 according to the proposal, a rotor which interacts magnetically with the stator coil arrangement 6.

As mentioned above, the induction motor can be an electric motor or generator. Any type of machine can be used. Examples of this are synchronous machines, which can be self-excited or externally excited, asynchronous machines or the like. Reference may be made to all explanations of the proposed stator 1.

According to a further teaching, which is also of independent significance, a method is proposed for producing a stator 1 for a rotary induction motor, with a stator main body 3 being provided, the stator 1 being assigned a geometric machine axis 4 and stator slots 5 arranged distributed around it in the stator main body 3, a stator coil arrangement 6 with a plurality of stator coil strings 7 being provided, which can be connected to a rotary supply voltage at respective phase terminals 8 in order to generate a rotary magnetic field, the stator coil strings 7 each having a bundle 9 with a plurality of conductors 10₁, 10₂, . . . 10ₙ, the conductors 10₁, 10₂, . . . 10ₙ of a bundle 9 being arranged together to form respective star inductors 11 in the stator slots 5, and the conductors 10₁, 10₂, . . . 10ₙ each having a phase-connection-side portion 12 and a star-point-side portion 13, the conductors 10₁, 10₂, . . . 10ₙ of a bundle 9 being electrically connected to the phase connection 8 of the respective stator coil string 7 via the phase-connection-side portion 12.

In the method according to the proposal, it is key that the conductors 10₁, 10₂, . . . 10ₙ of bundles 9 of different stator coil strings 7 are electrically connected to one another via the star-point-side portion 13 by means of respective star points 14₁, 14₂, . . . 14ₙ and that the star points 14₁, 14₂, . . . 14ₙ are electrically decoupled from one another. Reference may be made to all explanations of the proposed stator 1 and the proposed rotary induction motor.

It can be that the star inductors 11 are produced as star windings by means of a flyer winder, in some embodiments that the stator coil arrangement 6 has further bundles 16 with several conductors 10₁, 10₂, . . . 10ₙ, that the conductors 10₁, 10₂, . . . 10ₙ of the further bundles 16 are each arranged together to form delta windings in the stator slots 5, and that the conductors 10₁, 10₂, . . . 10ₙ of the further bundles 16 connect together the star points 14₁, 14₂, . . . 14ₙ of star point triplets 15₁, 15₂, . . . 15ₙ in a respective delta circuit and that the delta inductors 17 are produced as delta windings by means of a flyer winder.

As already mentioned with regard to the proposed stator 1, the proposed method allows simplified processing of the stator coil strings 7, wherein in particular a flyer winder can be used to produce wound inductors due to the comparatively small cross-sections of the conductors 10₁, 10₂, . . . 10ₙ of the bundles 9.

Alternatively or additionally, plug-in inductors can be used, in particular using hairpin technology.

1. A stator for a rotary induction motor with a stator main body, the stator being assigned a geometric machine axis, the stator having stator slots and a stator coil arrangement with a plurality of stator coil strands, which can be connected to a rotary supply voltage at respective phase terminals in order to generate a rotary magnetic field, the stator coil strings each having a bundle with a plurality of conductors the conductors of a bundle being arranged together to form respective star inductors of the stator coil string in the stator slots, and the conductors each having a phase-connection-side portion and a star-point-side portion the conductors of a bundle being electrically connected to the phase connection of the respective stator coil string via the phase-connection-side portion,
wherein the conductors of bundles of different stator coil strings are electrically connected to one another via the star-point-side portion by means of respective star points and wherein the star points are electrically decoupled from one another.

2. The stator as claimed in claim 1, wherein the conductors of bundles of different stator coil strings are connected to one another via the star-point-side portion by star point triplets.

3. The stator as claimed in claim 2, wherein the stator coil arrangement has further bundles with a plurality of conductors, wherein the conductors of the further bundles are each arranged together to form delta inductors in the stator slots, and wherein the conductors of the further bundles connect the star points of the star point triplets to one another in a respective delta circuit.

4. The stator as claimed in claim 1, wherein each conductor of a bundle is assigned exactly one star point or exactly one star point triplet to which the star-point-side portion is electrically connected.

5. The stator as claimed in claim 1, wherein the conductors of a bundle are arranged geometrically in a sequence with a respective conductor index in order to form the respective star windings in the stator slots, and wherein the conductors of bundles of different stator coil strings with different conductor indices are electrically connected to one another via the star-point-side portion.

6. The stator as claimed in claim 1, wherein the star inductors are designed as star windings.

7. The stator as claimed in claim 1, wherein the star inductors are each formed by a plurality of inductors, in particular star windings, electrically connected in series to a conductor.

8. The stator as claimed in claim 1, wherein the number of conductors per bundle is at most 20.

9. The stator as claimed in claim 1, wherein, for connecting the conductors of bundles of different stator coil strings via the star-point-side portion, electrical connecting elements are provided.

10. A rotary induction motor with a stator as claimed in claim 1 and a rotor which interacts magnetically with the stator coil arrangement.

11. A method for producing a stator for a rotary induction motor, with a stator main body being provided, with a geometric machine axis being assigned to the stator, with a stator coil arrangement with a plurality of stator coil strings being provided, which can be connected to a rotary supply voltage at respective phase connections in order to generate a rotary magnetic field, the stator coil strings each having a bundle with a plurality of conductors the conductors of a bundle being arranged together to form respective star inductors in stator slots in the stator main body, and the conductors each having a phase-connection-side portion and a star-point-side portion the conductors of a bundle being electrically connected to the phase connection of the respective stator coil string via the phase-connection-side portion,
wherein the conductors of bundles of different stator coil strings are electrically connected to one another via the star-point-side portion by respective star points and wherein the star points are electrically decoupled from one another.

12. The method as claimed in claim 11, wherein the star inductors are produced as star windings by a flyer winder.

13. The stator as claimed in claim 2, wherein the star point triplets are designed to be electrically decoupled from one another.

14. The stator as claimed in claim 7, wherein the inductors are star windings.

15. The stator as claimed in claim 6, wherein the delta inductors are designed as delta windings.

16. The stator as claimed in claim 1, wherein the number of conductors per bundle is at most 10.

17. The stator as claimed in claim 1, wherein the number of conductors per bundle is at most 7.

18. The stator as claimed in claim 9, wherein, the electrical connecting elements are arranged axially with respect to the machine axis on a stator front side and/or a stator rear side.

19. The stator as claimed in claim 9, wherein the connecting elements are provided as connecting conductors, connecting rails and/or connecting terminals.

20. The method as claimed in claim 12, wherein the stator coil arrangement has further bundles with a plurality of conductors, wherein the conductors of the further bundles are each arranged together to form delta windings in the stator slots, and wherein the conductors of the further bundles connect the star points of star point triplets to one another in a respective delta circuit, and wherein the delta inductors are produced as delta windings by a flyer winder.
